(19) United States
(12) Patent Application Publication
(10) Pub. No.: US 2026/0055717 A1
(43) Pub. Date: Feb. 26, 2026

(54) REDUCTANT DELIVERY SYSTEM, EXHAUST TREATMENT SYSTEM AND VEHICLE COMPRISING THE EXHAUST TREATMENT SYSTEM

(71) Applicant: Scania CV AB, Södertälje (SE)

(72) Inventors: Arun Prasath Karuppasamy, Nykvarn (SE); Disa Öqvist, Stockholm (SE)

(73) Assignee: Scania CV AB, Södertälje (SE)

(21) Appl. No.: 19/306,214

(22) Filed: Aug. 21, 2025

(30) Foreign Application Priority Data
Aug. 26, 2024 (SE) 2450867-3

(51) Int. Cl. F01N 3/20

(52) U.S. Cl. CPC F01N 3/2066; F01N 2610/02; F01N 2610/1453

(57) ABSTRACT

A reductant delivery system configured to supply a reductant into an exhaust stream in an exhaust treatment system is presented. The reductant delivery system comprises: an evaporator configured to mix the reductant with the exhaust stream flowing through the evaporator and a reductant doser configured to provide the reductant in spray form to a spray transforming device. The spray transforming device is configured between the reductant doser and at least one evaporating surface of the evaporator to receive the reductant in spray form the reductant doser, to transform the reductant from spray form to fluid form, and to deliver the reductant in fluid form at the at least one evaporating surface, such that the reductant is distributed as a liquid wall film on the at least one evaporating surface.

### CROSS-REFERENCE TO RELATED APPLICATION(S)

This application claims the benefit of priority to Swedish Patent Application No. 2450867-3 filed on Aug. 26, 2024; the contents of which are also incorporated herein by reference.

### TECHNICAL FIELD

The present invention relates to a reductant delivery system, an exhaust treatment system, and a vehicle comprising the exhaust treatment system.

### BACKGROUND

The following background description constitutes a description of the background to the present invention, and thus need not necessarily constitute prior art.

In connection with increased government interests concerning pollution and air quality, primarily in urban areas, emission standards and regulations regarding emissions from combustion engines have been drafted in many jurisdictions.

Such emission standards often consist of requirements defining acceptable limits of exhaust emissions from combustion engines in for example vehicles. For example, emission levels of nitrogen oxides NOₓ, hydrocarbons CₓH_{y}, carbon monoxide CO and particles PM are often regulated by such standards for most types of vehicles. Vehicles equipped with combustion engines typically give rise to such emissions in varying degrees. In this document, the invention will be described mainly for its application in vehicles, i.e. for internal combustion engines. However, the invention may be used in substantially any application where combustion engines are used, for example in vessels such as ships or aeroplanes/helicopters, wherein regulations and standards for such applications limit emissions from the combustion engines.

In an effort to comply with these emission standards, the exhausts caused by the combustion of the combustion engine are treated/purified.

A common way of treating exhausts from a combustion engine comprises a so-called catalytic purification process, which is why vehicles equipped with a combustion engine usually comprise at least one catalyst. There are different types of catalysts, where the different respective types may be suitable depending on for example the combustion concept, combustion strategies and/or fuel types which are used in the vehicles, and/or the types of compounds in the exhaust stream to be purified. In relation to at least nitrous gases (nitrogen monoxide, nitrogen dioxide), referred to below as nitrogen oxides NOₓ, vehicles often comprise a catalyst, wherein a reductant, also commonly denoted additive, is supplied to the exhaust stream resulting from the combustion in the combustion engine, in order to reduce nitrogen oxides NOₓ, primarily to nitrogen gas and aqueous vapour. This is described in more detail below.

SCR (Selective Catalytic Reduction) catalysts are a commonly used type of catalysts for this type of reduction, primarily for heavy goods vehicles. SCR catalysts usually use ammonia NH₃, or a composition from which ammonia may be generated/formed, as a reductant/additive used for reducing the amount of nitrogen oxides NOₓ in the exhausts. The reductant/additive, for example urea, is injected into the exhaust stream resulting from the combustion engine upstream of the catalyst. The reductant added to the catalyst is adsorbed/stored in the catalyst, in the form of ammonia NH₃, so that a redox-reaction may occur between nitrogen oxides NOₓ in the exhausts and ammonia NH₃ available via the reductant.

### SUMMARY

When the reductant is injected into the exhaust stream, i.e. when the reductant is supplied/injected/dosed into the exhaust treatment system, small particles may be created from the reductant at the injection/dosing, i.e. may be created by the supply of the reductant into the exhaust stream. These small reductant particles are individual solid reductant particles, i.e. are separate/non-continuous small-sized solid particles of the reductant. These small reductant particles are thus different from the continuous/non-separated/non-individual particles of a reductant fluid. The individual solid reductant particles are very small in size, and may for example have a diameter less than 23 nm, often in the range of 10 nm to 23 nm. These individual solid reductant particles are therefore sometimes called sub-23 nm reductant particles. The individual solid reductant particles may comprise urea and/or by-products based on urea.

Due to their small size, the solid reductant-based particles may flow with the exhaust stream through the entire exhaust treatment system and be emitted at the tailpipe. Thus, at least a portion of these individual solid reductant particles may, e.g. because of their small size, pass through each of the components of the exhaust treatment system, also through the SCR catalysts, and may be emitted into the environment as emissions. Measurements have shown that particles in the sub-23 nm range being measured in the tailpipe, i.e. being measured downstream of the exhaust treatment system, are often dominated by the small-sized solid reductant particles being formed/created at reductant dosing events in the exhaust treatment system.

The individual solid reductant particles may also comprise combustion-based particles, i.e. particles created at the combustion in the combustion engine. Thus, the individual solid reductant particles may then, due to possible interaction and/or mixing with particles from the combustion, comprise a mixture of reductant based particles and soot and/or ash. These small-sized reductant particles may thus, if being emitted, have health effects.

Also, the small-sized reductant particles may be included in future exhaust regulation. For example, according to some Euro 7 exhaust regulation proposals, particles having a diameter size from 10 nm are most likely to be included in the upcoming regulation. Thus, the more stringent particle emission limits in the Euro7 proposals means that, in addition to the limitation of combustion generated particles, also the small-sized solid reductant particles created by the dosing events are limited.

One objective of the present invention is therefore to at least partly prevent these small-sized solid reductant based particles from being created.

According to an aspect, the objective is achieved through the above mentioned reductant delivery system configured to supply a reductant into an exhaust stream in an exhaust treatment system. The exhaust stream is a result of a combustion in a combustion engine and the exhaust treatment system is configured for treatment of the exhaust stream by utilization of the reductant.

The reductant delivery system comprises:
an evaporator configured to mix the reductant with the exhaust stream flowing through the evaporator;
a reductant doser configured essentially in a center of a cross section of the evaporator to provide the reductant in spray form to a spray transforming device, the cross section being perpendicular to a flow direction of the exhaust stream; and
the spray transforming device configured between the reductant doser and at least one evaporating surface of the evaporator to receive the reductant in spray form from the reductant doser, to transform the reductant from spray form to fluid form, and to deliver the reductant in fluid form at the at least one evaporating surface, such that the reductant is distributed as a liquid wall film on the at least one evaporating surface.

Hereby, the small individual solid reductant particles, possibly having a diameter in the interval of 10 to 23 nm, are at least partly prevented from being created, and are thus prevented from being included in the exhaust stream.

By preventing the individual solid reductant particles from being created, by utilization of the herein presented reductant delivery system, the number of such particles being emitted from the tailpipe is considerably reduced, as compared to conventional solutions.

Thus, instead of adding additional components, such as for example different kinds of filters, in the exhaust treatment system in order to try to catch and/or dissolve such small individual solid reductant particles being carried by the exhaust stream before the particles are emitted from the tailpipe, the herein presented reductant delivery system at least partially prevents the small individual solid reductant particles from being created at all. In other words, the herein presented reductant delivery system focusses on taking action against, i.e. counteracting, the source/cause of these small individual solid reductant particles instead of trying to handle the effects of already created particles, which has been the focus of known solutions. Hereby, problems which would otherwise be caused by such additional components for removing the particles, such as e.g. problems related to back pressure, increased fuel consumption and/or additional manufacturing costs, may be avoided when the herein presented reductant delivery system is used.

An exhaust treatment system comprising a reductant delivery system as herein described has the potential to meet the emission requirements in current and/or future emission standards, especially since the amount of small individual solid reductant particles being emitted from the tailpipe is considerably reduced.

According to an embodiment, the spray transforming device is configured as a cone formed wheel comprising:
a hub configured at a top of the cone, wherein the hub comprises at least one spray transforming surface configured to receive the reductant in spray form from the reductant doser and to transform the reductant from spray form to fluid form;
two or more spokes configured from the hub to a rim of the spray transforming device, each spoke comprising a channel configured to provide the reductant in fluid form from the at least one spray transforming surface to the rim; and
the rim configured at a base of the cone, downstream of the hub, to provide the reductant in fluid form at the at least one evaporating surface.

The cone formed wheel spray transforming device, comprising a hub, a number of spokes and a rim, is mechanically robust. The rim, being configured at the at least one evaporating surface facilitates an essentially even distribution of the reductant/additive as a liquid wall film on the at least one evaporating surface. Hereby, the decomposition of urea in the reductant into ammonia becomes efficient. Also, the speed of the mixing of the reductant with the emissions, e.g. with the exhaust gas, and/or of the vaporisation of the reductant is also increased.

According to an embodiment, the evaporator comprises two or more concentric evaporation pipes through which the exhaust stream flows, the two or more concentric evaporation pipes forming two or more evaporation surfaces, respectively; and
the spray transforming device is configured as a two or more cone formed wheels having differing base diameters, wherein each cone formed wheel comprises:
   a hub configured at a top of the cone, wherein the hub comprises at least one spray transforming surface configured to receive the reductant in spray form from the reductant doser and to transform the reductant from spray form to fluid form;
   two or more spokes configured from the hub to a rim of the spray transforming device, each spoke comprising a channel configured to provide the reductant in fluid form from the hub to the rim; and
   the rim configured at a base of the cone, downstream of the hub, and being configured to provide the reductant in fluid form at the at least one evaporating surface.

By increasing the number of evaporation pipes to two or more, the total evaporation surface of the evaporator is considerably increased. Hereby, the efficiency of the mixing of the reductant with the emissions, e.g. with the exhaust gas, and/or of the vaporisation of the reductant is improved.

According to an embodiment, the two or more channels of the two or more spokes are arranged on the surfaces of the two or more spokes, respectively.

Hereby, a low-cost manufacturing of the spray transforming device is possible.

According to an embodiment, the two or more channels of the two or more spokes are arranged in two or more tunnels under the surfaces of the two or more spokes, respectively.

Hereby, the channels, and thus also the reductant, are concealed and protected, such that the reductant may be safely provided to the at least one evaporation surface.

According to an embodiment, the spray transforming device is arranged separate from the reductant doser, at an axial distance downstream of the reductant doser.

Hereby, the reductant delivery device, especially the reductant doser and the spray transforming device, may be designed with a large degree of freedom. For example, conventional reductant dosers may be used for this embodiment.

According to an embodiment, the spray transforming device is arranged downstream of the reductant doser and attached to the reductant doser.

Hereby the sprayed reductant is concealed and protected within the joint between the reductant doser and the spray transforming device, such that it may be safely delivered to the at least one evaporation surface.

According to an embodiment, at least one spray transforming surface of the spray transforming device is arranged concealed within a joint between the reductant doser and the spray transforming device.

Hereby, the transformation of reductant from spray form into fluid/liquid form is protected by the joint, such that the transformation may be efficiently performed and such that the reductant may be safely delivered to the at least one evaporation surface.

According to an embodiment, the delivery of the reductant in fluid form at the at least one evaporating surface is configured to avoid transforming the reductant from fluid form into spray form when providing the reductant to the at least one evaporating surface after the reductant has been transformed into fluid form by the spray transforming device.

Hereby, the reductant is safely delivered in fluid form onto the at least one evaporating surface, such that the risk for creation of the small individual solid reductant particles is minimized.

According to an embodiment, the delivery of the reductant in fluid form at the at least one evaporating surface is configured to prevent individual solid particles having a diameter less than 23 nm from being created by the supply of the reductant into the exhaust stream.

The amount of such small individual solid reductant particles being emitted from the tailpipe is hereby considerably reduced.

According to an embodiment, the individual solid particles comprise one or more in the group of:
urea; and
by-products based on urea.

By preventing these individual solid particles from being created, the dosing of urea upstream of the one or more SCR catalysts may be performed to optimize the reduction of nitrogen oxides NOₓ of the exhausts in the one or more SCR catalysts, essentially without considering possible emission of such individual solid particles.

According to an embodiment, the reductant comprises one or more in the group of:
ammonia; and
a substance from which ammonia may be extracted and/or released.

A reductants comprising ammonia provides for an efficient reduction of nitrogen oxides NOₓ in the exhausts by usage of the one or more SCR catalysts.

According to an embodiment, the spray transforming device is configured to deliver the reductant at a distance D in an interval of 0-10 mm from the at least one evaporating surface.

By delivery of the reductant at a distance D in an interval of 0-10 mm from the at least one evaporating surface, i.e. directly onto or immediately adjacent to the at least one evaporating surface, the reductant is kept in fluid form, after its initial transformation, until it is distributed onto the at least one evaporating surface. This reduces the risk for creation of the individual solid reductant particles.

According to an aspect, the objective is achieved through the above mentioned exhaust treatment system arranged for treatment of an exhaust stream resulting from a combustion in a combustion engine. The exhaust treatment system comprises:
a particulate filter arranged to catch soot and ash created by the combustion;
the herein described reductant delivery system arranged downstream of the particulate filter, the reductant delivery system being configured to mix the reductant with the exhaust stream; and
a selective catalytic reduction catalyst arranged downstream of the reductant delivery system for reduction of nitrogen oxides NOₓ in the exhaust stream by utilization of the supplied reductant.

The exhaust treatment system has corresponding advantages as mentioned for the reductant delivery system.

According to an aspect, the objective is achieved through the above mentioned exhaust treatment system arranged for treatment of an exhaust stream resulting from a combustion in a combustion engine. The exhaust treatment system comprises:
an upstream dosing device arranged to supply a reductant into the exhaust stream;
an upstream selective catalytic reduction catalyst arranged downstream of the upstream dosing device for reduction of nitrogen oxides NOₓ in the exhaust stream by utilizing the supplied reductant;
a particulate filter arranged downstream of the upstream selective catalytic reduction catalyst to catch soot and ash created by the combustion;
the herein described reductant delivery system arranged downstream of the particulate filter, the reductant delivery system being configured to mix the reductant with the exhaust stream; and
a downstream selective catalytic reduction catalyst arranged downstream of the reductant delivery system to reduce nitrogen oxides NOₓ in the exhaust stream by utilizing the supplied reductant.

The exhaust treatment system has corresponding advantages as mentioned for the reductant delivery system.

According to an aspect, the objective is achieved through the above mentioned vehicle comprising an exhaust treatment system comprising the herein described reductant delivery system.

The vehicle has corresponding advantages as mentioned for the reductant delivery system.

### BRIEF LIST OF FIGURES

The invention will be illustrated in more detail below, along with the enclosed drawings, where similar references are used for similar parts, and where:

FIG. 1 shows an example vehicle which may comprise a reductant delivery system and/or an exhaust treatment system according to various aspects and/or embodiments of the present invention,

FIG. 2 shows an example of an exhaust treatment system in which aspects and/or embodiments of the present invention may be implemented,

FIG. 3 shows an example of an exhaust treatment system in which aspects and/or embodiments of the present invention may be implemented,

FIG. 4 shows a reductant delivery system according to some aspects and/or embodiments of the present invention,

FIGS. 5a-b show various views of a spray transforming device according to some embodiments of the present invention,

FIGS. 6a-b show various views of a spray transforming device according to some embodiments of the present invention,

FIGS. 7a-c shows a reductant delivery system and various views of a spray transforming device according to some embodiments of the present invention, and

FIGS. 8a-e show various views of an evaporator and a spray transforming device according to some embodiments of the present invention.

### DETAILED DESCRIPTION

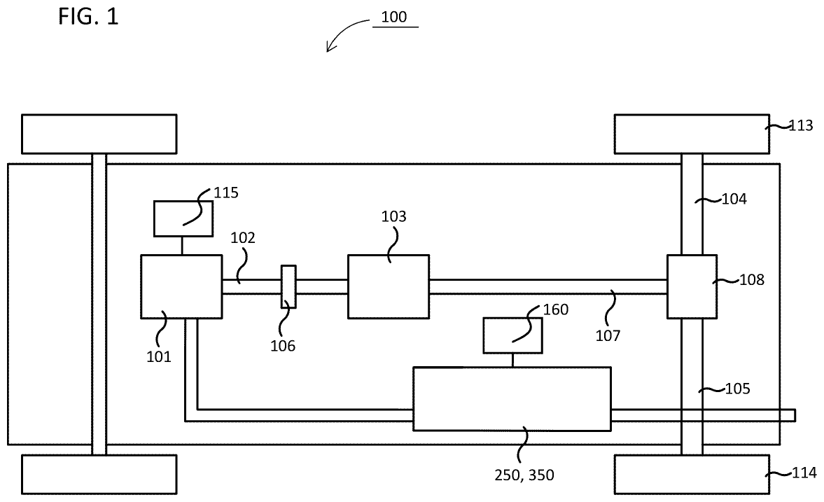

FIG. 1 schematically shows an example vehicle 100 comprising an exhaust treatment system 250, 350, which may be an exhaust treatment system 250, 350 according to an aspect or embodiment of the present invention. The powertrain of the vehicle comprises a combustion engine 101, which in a customary manner, via an output shaft 102 of the combustion engine 101 is connected to a gearbox 103 via a clutch 106. An output shaft 107 from the gearbox 103 may drive the wheels 113, 114 e.g. via a final drive 108, such as e.g. a customary differential, and the drive shafts 104, 105 connected to the final drive 108.

The combustion engine 101, e.g. an internal combustion engine, may be controlled by the engine's control system via a control device 115. Likewise, the clutch 106 and the gearbox 103 may be controlled by the vehicle's control system, with the help of one or more applicable control devices (not shown). Naturally, the vehicle's powertrain may also be of another type, such as a type with a conventional automatic gearbox, or a type with a hybrid driveline, etc.

The vehicle 100 also comprises an exhaust treatment/purification system 250, 350 for treatment/purification of exhaust emissions resulting from combustion in the combustion chamber of the combustion engine 101.

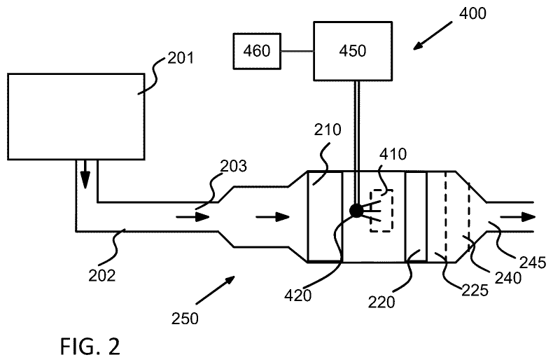

FIG. 2 shows an exhaust treatment system 250, which may illustrate a so-called Euro VI-system. The exhaust treatment system 250 is connected to a combustion engine 201, e.g. an internal combustion engine, e.g. via an exhaust conduit 202, wherein the exhausts generated at the combustion, that is to say the exhaust stream 203, is indicated with arrows. The exhaust stream 203 is led to a coated diesel particulate filter (cDPF) 210, which is coated with a catalytically oxidising coating, for example comprising at least one precious metal. Alternatively, a diesel oxidation catalyst (DOC) followed downstream by an uncoated diesel particulate filter (DPF) or a coated diesel particulate filter (cDPF) may be arranged in the exhaust treatment system 250 instead of the coated diesel particulate filter. Thus, either of a coated diesel particulate filter, and a diesel oxidation catalyst followed by a diesel particulate filter (DPF/cDPF) is arranged downstream of the combustion engine 201 in the exhaust treatment system 250.

During the combustion in the combustion engine 201, soot and ash are created, and the coated diesel particulate filter 210, or alternatively the diesel particulate filter, is used to catch the soot and ash. The exhaust stream 203 is here led through a filter structure, wherein soot and ash from the exhaust stream 203 are caught when passing through, and are stored in the particulate filter 210.

The catalytic coating in the coated diesel particulate filter 210, or alternatively in the oxidation catalyst, has several functions and is normally used primarily to oxidize, during the exhaust treatment, remaining hydrocarbons CₓH_{y} (also referred to as HC) and carbon monoxide CO in the exhaust stream 203 into carbon dioxide CO₂ and water H₂O. Also, a large fraction of the nitrogen monoxides NO occurring in the exhaust stream may be oxidized into nitrogen dioxide NO₂. The oxidation of nitrogen monoxide NO into nitrogen dioxide NO₂ is important to the nitrogen dioxide-based soot and ash oxidation in the filter, and is also advantageous at a potential subsequent reduction of nitrogen oxides NOₓ.

In this respect, the exhaust treatment system 250 further comprises a selective catalytic reduction (SCR) catalyst 220 arranged downstream of the diesel particulate filter 210. The selective catalytic reduction catalyst 220 uses ammonia NH₃, or a composition from which ammonia may be generated/formed, e.g. urea, as a reductant/additive for the reduction of nitrogen oxides NOₓ in the exhaust stream 203. After passing through the components of the exhaust treatment system, the exhaust stream is emitted into the environment at the tailpipe 245.

The reaction rate of this reduction is impacted, however, by the ratio between nitrogen monoxide NO and nitrogen dioxide NO₂ in the exhaust stream, so that the reductive reaction is impacted in a positive direction by the previous oxidation of NO into NO₂ in the coated diesel particulate filter, or alternatively in the oxidation catalyst DOC.

The selective catalytic reduction catalyst 220 requires a reductant/additive to reduce the concentration of a compound, such as for example nitrogen oxides NOₓ, in the exhaust stream 203. Such reductant is injected into the exhaust stream downstream of the particulate filter 210 and upstream of the selective catalytic reduction catalyst 220, by a reductant doser 420 of a reductant delivery system 400 shown in FIG. 2. The reductant doser 420 may also be denoted reductant/additive dosing/injection arrangement/device. The reductant/additive is often ammonia and/or urea based, or consists of a substance from which ammonia may be extracted or released, and may for example consist of AdBlue, which basically consists of urea mixed with water. Urea forms ammonia at heating (thermolysis) and at heterogeneous catalysis on an oxidizing surface (hydrolysis), which surface may, for example, consist of titanium dioxide TiO2, within the selective catalytic reduction catalyst 220. The exhaust treatment system may also comprise a separate hydrolysis catalyst. The reductant may be provided from a container/tank 450 of the reductant delivery system 400, and the dosing of the reductant may be controlled by a control unit/system 460. The reductant delivery system 400 is explained more in detail below.

An evaporator 410, which may comprise substantially any suitable hydrolysis coating, and/or a mixer, is arranged at the reductant doser 420. The hydrolysis catalyst, and/or the mixer, are then used to increase the speed of the decomposition of urea into ammonia, and/or to mix the additive with the emissions, and/or to vaporize the additive.

The exhaust treatment system 250 may further be equipped with a slip-catalyst (SC) 240, which is arranged downstream of the selective catalytic reduction catalyst 220 to oxidize an excess of ammonia that may remain in the exhausts after the selective catalytic reduction catalyst 220, an/or to assist the selective catalytic reduction catalyst 220 with further reduction of NOₓ. Accordingly, the slip-catalyst 240 may provide a potential for improving the system's total conversion/reduction of NOₓ.

The exhaust treatment system 250 may also be equipped with one or several sensors, such as one or several NOₓ and/or temperature sensors for the determination of nitrogen oxides and/or temperatures in the exhaust treatment system.

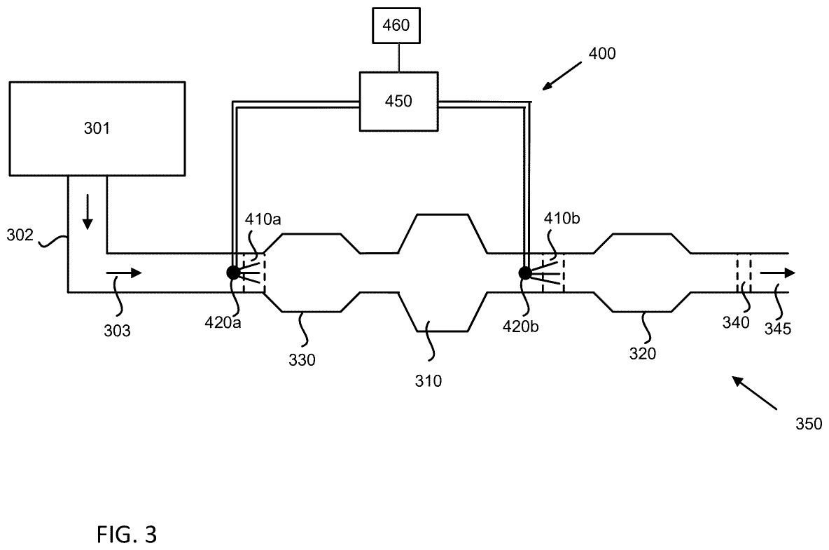

FIG. 3 schematically shows another exhaust treatment system 350, which is connected via an exhaust pipe 302 to a combustion engine 301, e.g. an internal combustion engine. Exhausts are generated at combustion in the engine 301 and the exhaust stream 303 (indicated with arrows) are led to an upstream reductant doser 420a of a reductant delivery system 400, arranged to add/inject a reductant/additive into the exhaust stream 303. An upstream selective catalytic reduction (SCR) catalyst 330 is arranged downstream of the upstream reductant doser 420a. The upstream selective catalytic reduction catalyst 330 is arranged to reduce nitrogen oxides NOₓ in the exhaust stream 303, through the use of the reductant added to the exhaust stream by the upstream reductant doser 420a. In more detail, the upstream selective catalytic reduction catalyst 330 uses the reductant, for example ammonia NH₃, or a substance from which ammonia may be generated/formed/released, for the reduction of nitrogen oxides NOₓ in the exhaust stream 303. This additive may for example consist of the above mentioned AdBlue, and may be provided from a container/tank 450 of the reductant delivery system 400. The injection of the reductant may be controlled by a control unit/system 460.

Downstream of the upstream selective catalytic reduction catalyst 330, the exhaust treatment system 350 further comprises a coated diesel particulate filter (cDPF) 310, which is coated with a catalytically oxidising coating, for example comprising at least one precious metal for catching and oxidising soot and ash. Alternatively, a diesel oxidation catalyst (DOC) followed downstream by a diesel particulate filter (DPF/CDPF) may be arranged in the exhaust treatment system 350 instead of the coated diesel particulate filter. Thus, either of a coated diesel particulate filter and a diesel oxidation catalyst followed by a diesel particulate filter (DPF/cDPF) is arranged downstream of the upstream reduction catalyst device 330 in the exhaust treatment system 350.

Downstream of the particulate filter 310, the exhaust treatment system 350 comprises a downstream reductant doser 420b of the reductant delivery system 400, which is arranged to supply reductant into the exhaust stream 303, where such a second reductant comprises ammonia NH₃, or a substance, for example AdBlue, from which ammonia may be generated/formed/released, as described above. The downstream reductant may here be the same additive as the above mentioned reductant/additive injected by the upstream reductant doser 420a, and may possibly also come from the same container/tank 450. Alternatively, the reductants injected by the upstream 420a and downstream 422 reductant dosers, respectively, may also be of different types and/or may come from different tanks. The injection performed by the downstream reductant doser 420b may be controlled by a control unit/system 460.

An evaporator 410a, 410b may be arranged at the upstream 420a and/or downstream 420b reductant dosers, respectively, to increase the speed of the decomposition of urea into ammonia, and/or to mix the additive with the emissions, and/or to vaporize the additive.

The exhaust treatment system 350 also comprises a downstream selective catalytic reduction (SCR) catalyst 320, which is arranged downstream of the downstream reductant doser 420b. The downstream selective catalytic reduction catalyst 320 is arranged to reduce nitrogen oxides NOₓ in the exhaust stream 303 through use of the reductant injected by the downstream reductant doser 420b, and possibly also reductant remaining in the exhaust stream 303 which was injected by the upstream reductant doser 420a.

The exhaust treatment system 350 may further be equipped with a slip-catalyst (SC) 340, which is arranged downstream of the downstream selective catalytic reduction catalyst 320 to oxidize an excess of ammonia that may remain in the exhausts after the downstream selective catalytic reduction catalyst 320, an/or to assist the selective catalytic reduction catalyst 320 with further reduction of NOₓ. Accordingly, the slip-catalyst 340 may provide a potential for improving the system's total conversion/reduction of NOₓ.

After passing through the components of the exhaust treatment system 350, the exhaust stream is emitted into the environment at the tailpipe 345 of the exhaust treatment system 350.

The exhaust treatment system 350 may also be equipped with one or several sensors (not shown), such as one or several NOₓ sensors and/or one or several temperature sensors, which are arranged for the determination of NOₓ-concentrations and temperatures in the exhaust treatment system 350, respectively.

Through the use of the exhaust treatment system 350 shown in FIG. 3, both the upstream selective catalytic reduction catalyst 330 and the downstream selective catalytic reduction catalyst 320 may be optimized with respect to a selection of catalyst characteristics for the reduction of nitrogen oxides NOₓ, and/or with respect to volumes for the upstream 330 and downstream 320 selective catalytic reduction catalysts, respectively.

The particulate filter 310 may hereby be used to improve the efficiency, by taking into account how its thermal mass, i.e. its thermal inertia, impacts the temperature of the downstream selective catalytic reduction catalyst 320. By taking into account the thermal inertia of the particulate filter 310, the upstream selective catalytic reduction catalyst 330 and the downstream selective catalytic reduction catalyst 320, respectively, may be optimized with respect to the specific temperature function each will experience.

For both the upstream 330 and downstream 320 selective catalytic reduction catalysts, its catalytic characteristics may be selected based on the environment to which it is exposed, or will be exposed to. Additionally, the catalytic characteristics for the upstream 330 and downstream 320 selective catalytic reduction catalyst may be adapted so that they may be allowed to operate in symbiosis with each other. The upstream 330 and downstream 320 selective catalytic reduction catalysts may also comprise one or several materials, providing the catalytic characteristic. For example, transition metals such as vanadium and/or tungsten may be used, for example in a catalyst comprising V₂O₅/WO₃/TiO₂. Metals such as iron and/or copper may also be comprised in the upstream 330 and/or downstream 320 selective catalytic reduction catalysts, for example in a Zeolite-based catalyst.

The exhaust treatment system 350 reduces the amount of nitrogen oxides NOₓ in the exhaust stream in substantially all driving modes, comprising especially cold starts and throttle, that is to say increased requested torque.

The above mentioned small-sized individual solid reductant particles may be created by the supply of the reductant/additive into the exhaust stream 203, 303, and may comprise urea and/or by-products based on urea, as mentioned above. In the exhaust treatment system illustrated in FIG. 2, the individual solid reductant particles may thus be created at the reductant doser 420 and/or the evaporator 410. In the exhaust treatment system illustrated in FIG. 3, the individual solid reductant particles may thus be created at the upstream reductant doser 420a, at the downstream reductant doser 420b and/or at the corresponding evaporators 410a, 410b.

According to an aspect of the present invention, a reductant delivery system 400 configured to supply a reductant into an exhaust stream 203, 303 in an exhaust treatment system 250, 350 is presented. The exhaust stream 203, 303 is a result of a combustion in a combustion engine 201, 301 and the exhaust treatment system 250, 350 is configured for treatment of the exhaust stream 203, 303 by utilization of the reductant.

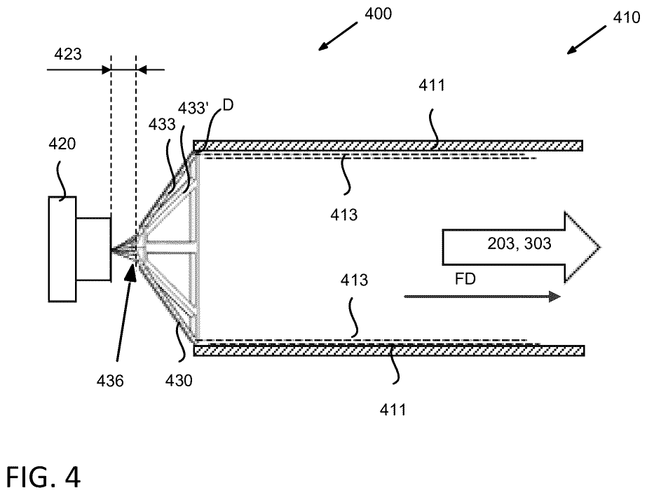

The reductant delivery system 400 comprises an evaporator 410, schematically illustrated for various embodiments in FIGS. 4, 7a, and 8a-c. The evaporator 410 is configured to mix the reductant with the exhaust stream 203, 303 flowing through the evaporator 410.

The reductant delivery system 400 further comprises a reductant doser 420 configured essentially in a center C of a cross section of the evaporator 410 to provide the reductant in spray form, i.e. as a spray, to a spray transforming device 430. The cross section of the evaporator 410 is perpendicular to a flow direction FD of the exhaust stream 203, 303, i.e. is perpendicular to a longitudinal/axial direction/extension of the evaporator 410. According to an embodiment, the evaporator 410 has an essentially circular cross section.

The reductant delivery system 400 further comprises a spray transforming device 430 configured between the reductant doser 420 and at least one evaporating surface 411, 411a, 411b of the evaporator 410. The spray transforming device 430 is configured to receive the reductant in spray form the reductant doser 420. The spray transforming device 430 is further configured to transform the reductant from spray form into fluid form. The spray transforming device 430 is further configured to deliver the reductant in fluid form at the at least one evaporating surface 411, 411a, 411b, such that the reductant is distributed as a liquid wall film 413, 413a, 413b on the at least one evaporating surface 411, 411a, 411b.

According to an embodiment, the delivery of the reductant in fluid form at the at least one evaporating surface 411, 411a, 411b is configured such that a transformation of the reductant from fluid form into spray form is avoided when providing the reductant to the at least one evaporating surface 411, 411a, 411b, i.e. after the reductant has been initially transformed into fluid form by the spray transforming device 430. Thus, the spray transforming device 430 first transforms the sprayed reductant received from the reductant doser 420 into fluid form. Thereafter, a retransformation of the reductant into spray form again is avoided by the herein presented reductant delivery system 400.

According to an embodiment, the delivery of the reductant in fluid form at the at least one evaporating surface 411, 411a, 411b is performed such that creation of individual solid particles having a diameter less than 23 nm by the supply of the reductant into the exhaust stream 203, 303 is prevented. Thus, by usage of the presented reductant delivery system 400, the number of individual solid particles having a diameter less than 23 nm being emitted into the environment at the tailpipe is considerably reduced.

According to an embodiment, wherein the spray transforming device 430 is configured to deliver the reductant at a distance D from the at least one evaporating surface 411, 411a, 411b, where the distance D is in an interval of 0-10 mm. Thus, the reductant is essentially delivered/applied directly onto the at least one evaporating surface 411, 411a, 411b such that it is distributed as a liquid wall film 413, 413a, 413b on the at least one evaporating surface 411, 411a, 411b.

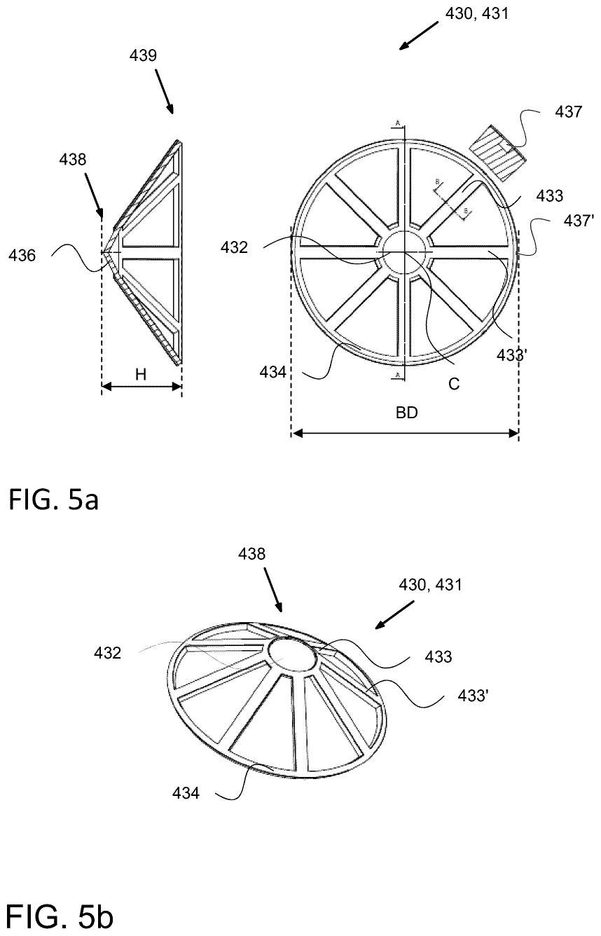

According to an embodiment schematically shown in FIGS. 4, 5a-b, 6a-b and 7a-c, the spray transforming device 430 is configured as a cone formed wheel 431, which comprises a hub 432 configured at a top 438 of the cone. The cone formed wheel 431 has a base diameter BD in a radial plane perpendicular to the flow direction FD and a height H in the axial plane, i.e. in the flow direction FD. The hub 432 comprises at least one spray transforming surface 436 configured to receive the reductant in spray form from the reductant doser 410 and to transform the reductant from spray form to fluid form. The reductant spray is transformed by immediately impacting one or more surfaces adjacent/close to the orifice in order to avoid droplet break-up. The closeness between the orifice of the reductant doser and the one or more spray transforming does not allow sufficient travelling time and distance for the droplets to break up.

The spray transforming device 430, i.e. the cone formed wheel 431, further comprises two or more spokes 433, 433′ configured to extend from the hub 432 to a rim 434 of the spray transforming device 430. Each spoke 433, 433′ comprises a channel 435, 435′, 437, 437′ configured to provide the reductant in fluid form from the at least one spray transforming surface 436 to the rim 434 of the cone formed wheel 431.

According to an embodiment, the channels 435, 435′, 437, 437′ of the two or more spokes 433, 433′ of the cone formed wheel 431 are sufficiently small, i.e. the depths/volumes of the channels 435, 435′, 437, 437′ are sufficiently small, to be filled the injected reductant in fluid form. Hereby, the reductant is provided in fluid form from the hub 432 to the rim 434 of the cone formed wheel 431. The rim 434 of the cone formed wheel 431 is configured at a base 439 of the cone formed wheel 431, downstream of the hub 432. The rim 434 is configured to provide the reductant in fluid form at the at least one evaporating surface 411, 411a, 411b. The reductant in fluid form is thus transported through the channels 435, 435′, 437, 437′ and is distributed at the rim 434 as a liquid wall film 413, 413a, 413b on the at least one evaporating surface 411, 411a, 411b.

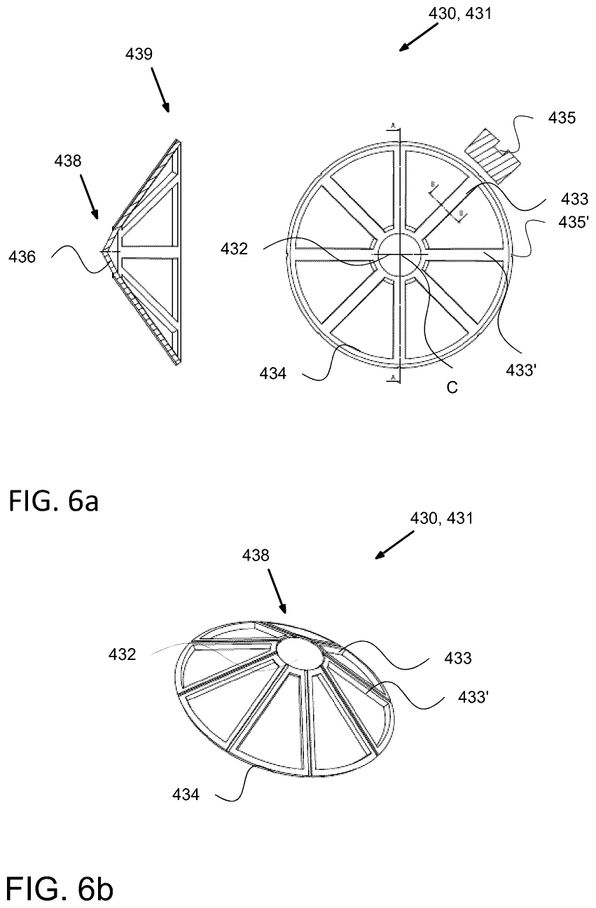

According to an embodiment schematically illustrated in FIGS. 6a-b, the two or more channels 435, 435′ of the two or more spokes 433, 433′ are arranged on the surfaces of the two or more spokes 433, 433′, respectively. Thus, the two or more channels 435, 435′ are here configured as notches on the spoke surfaces.

According to another embodiment illustrated in FIGS. 5a-b, 7b-c and 8d-e the two or more channels 437, 437′, 437a, 437b of the two or more spokes 433, 433′, 433a, 433a′, 433b, 433b′ are arranged in two or more tunnels 437, 437′, 437a, 437b under the surfaces of the two or more spokes 433, 433′, 433a, 433a′, 433b, 433b′, respectively. Thus, the two or more channels 437, 437′, 437a, 437b are here configured as covered holes/notches in the spokes 433, 433′, 433a, 433a′, 433b, 433b′.

According to an embodiment schematically illustrated in FIG. 4, the spray transforming device 430 is arranged separate from the reductant doser 420, at an axial distance 423 downstream of the reductant doser 420. Thus, the reductant here travels in air the distance 423 from the reductant doser 420 to the spray transforming device 430.

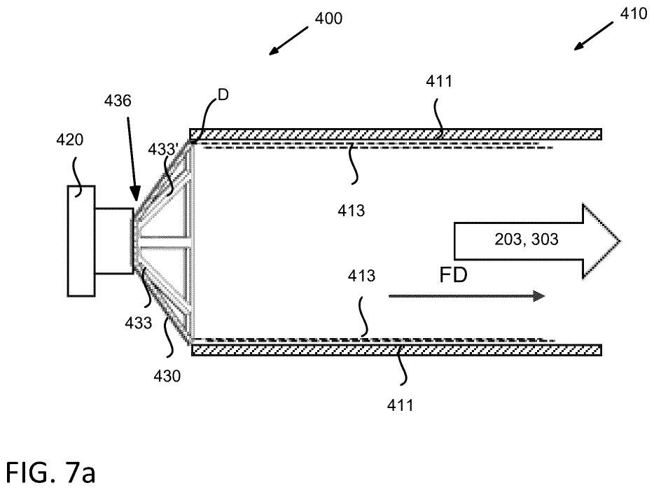

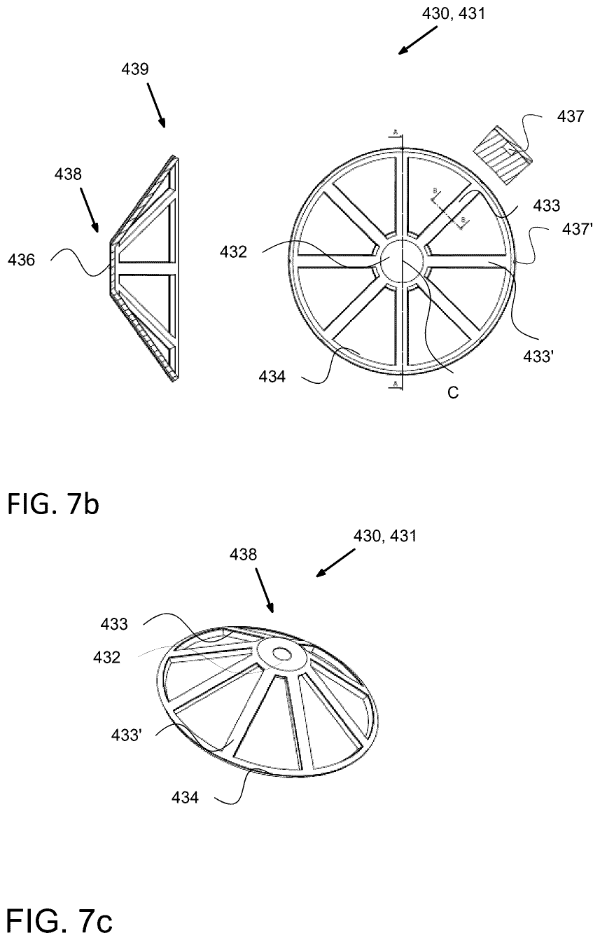

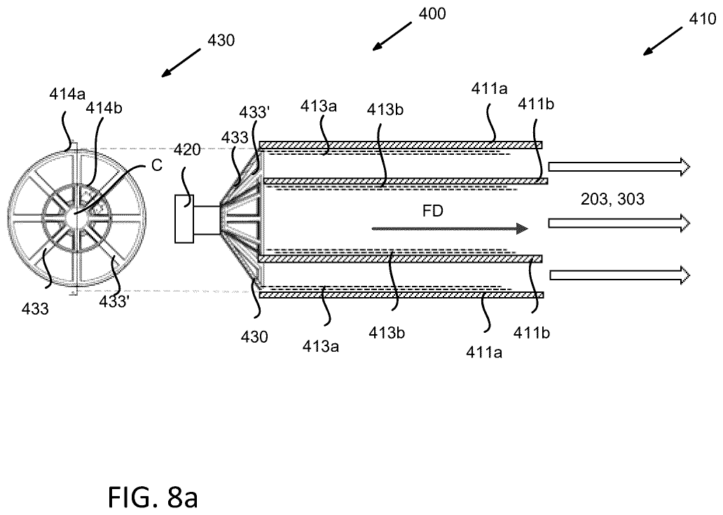

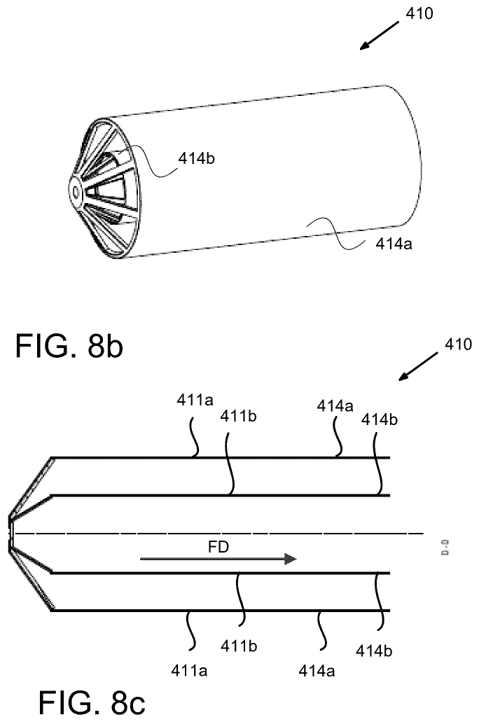

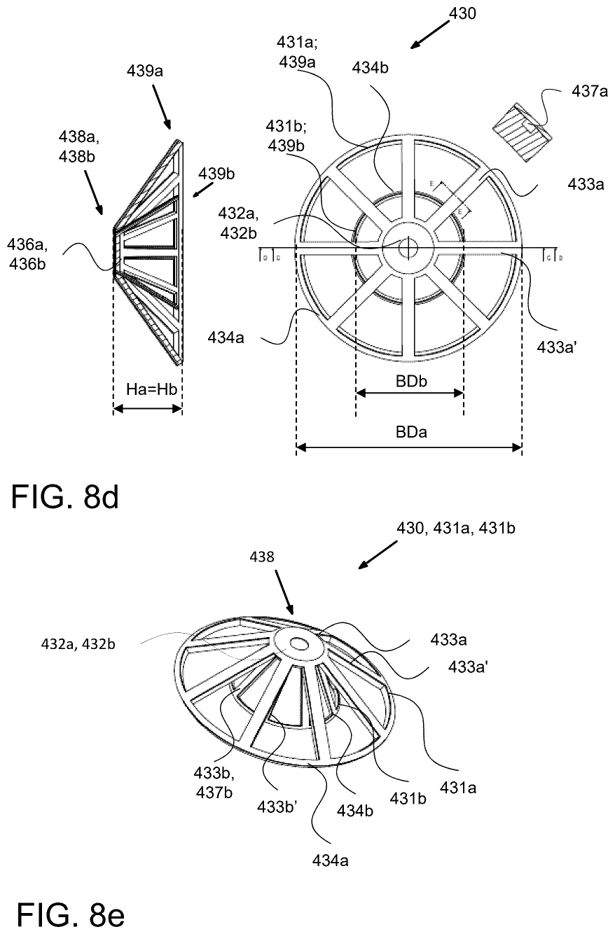

According to another embodiment schematically illustrated in FIGS. 7a and 8a, the spray transforming device 430 is arranged downstream of the reductant doser 420 and attached to the reductant doser 420. Thus, the reductant doser 420 and the spray transforming device 430 are here fitted together. The at least one spray transforming surface 436, 436a, 436b of the spray transforming device 430 is then arranged concealed within the joint between the reductant doser 420 and the spray transforming device 430, such that the reductant is sprayed from the reductant doser 420 to the spray transforming device 430 inside of this joint.

According to an embodiment schematically illustrated in FIGS. 8a-e, the evaporator 410 comprises two or more concentric evaporation pipes 414a, 414b through which the exhaust stream 203, 303 flows. These two or more concentric evaporation pipes 414a, 414b form two or more evaporation surfaces 411a, 411b, respectively, as schematically illustrated in FIGS. 8a and 8c.

The spray transforming device 430 is then configured as a two or more cone formed wheels 431a, 431b having differing base diameters BDa, BDb in a radial plane perpendicular to the flow direction FD, and the same or differing heights Ha, Hb in the axial plane, i.e. in the flow direction FD, as shown in FIG. 8d. Each such cone formed wheel 431a, 431b comprises a hub 432a, 432b configured at a top 438a, 438b of the cone, wherein the hub 432a, 432b comprises at least one spray transforming surface 436a, 436b configured to receive the reductant in spray form from the reductant doser 420 and to transform the reductant from spray form into fluid form, as described above.

Each of the cone formed wheels 431a, 431b further comprises two or more spokes 433a, 433a′, 433b, 433b′ configured from the hub 432a, 432b to a rim 434a, 434b of the spray transforming device 430. Each of the cone formed wheels 431a, 431b may have essentially any number of two or more spokes.

Each spoke 433a, 433a′, 433b, 433b′ comprises a channel 437a, 437b configured to provide the reductant in fluid form from the hub 432a, 432b to the rim 434a, 434b. According to various embodiments, these channels 437a, 437b of the spokes 433a, 433a′, 433b, 433b′ of the two or more cone formed wheels 431a, 431b may be either arranged e.g. as notches on the surfaces of the two or more spokes 433a, 433a′, 433b, 433b′ and/or arranged as tunnels within the two or more spokes 433a, 433a′, 433b, 433b′.

Each of the cone formed wheels 431a, 431b further comprises a rim 434a, 434b configured at a base 439a, 439b of each of the cones. The outer cone formed wheel 431a has a larger base diameter BDa than the base diameter BDb of the inner cone formed wheel 431b. The outer cone formed wheel 431a may have essentially the same height Ha as the height Hb of the inner cone formed wheel 431b; Ha=Hb; or may have a different height Ha than the height Hb of the inner cone formed wheel 431b; Ha≠Hb. The rim 434a, 434b is arranged downstream of the hub 432a, 432b, such that the hub 432a, 432b is directed towards the reductant doser 420 and the rim 434a, 434b is directed towards the tailpipe of the exhaust treatment system 250, 350. The rim 434a, 434b is further configured to provide the reductant in fluid form at the at least one evaporating surface 411a, 411b. Thus, the reductant is via the rim 434a, 434b distributed as a liquid wall film 413a, 413b on the at least one evaporating surface 411a, 411b.

Although FIGS. 8a-e schematically illustrate a spray transforming device 430 having at least one spray transforming surface 436a, 436b being arranged concealed within the joint between the reductant doser 420 and the spray transforming device 430, the spray transforming device 430 may also be arranged separate from the reductant doser 420, as described above. Further, any herein described distribution of the reductant onto the two or more evaporation surfaces 411a, 411b may be utilized in this embodiment.

According to an embodiment, the herein described reductant delivery system 400 is utilized in an exhaust treatment system 250 as illustrated in FIG. 2, i.e. in an exhaust treatment system 250 arranged for treatment of an exhaust stream 203 resulting from a combustion in a combustion engine 201. The exhaust treatment system 250 comprises a particulate filter 210 arranged to catch soot and ash created by the combustion. The exhaust treatment system 250 further comprises the herein described reductant delivery system 400 arranged downstream of the particulate filter 210, where the reductant delivery system 400 is configured to mix the reductant with the exhaust stream 203. The exhaust treatment system 250 further comprises a selective catalytic reduction catalyst 220 arranged downstream of the reductant delivery system 400 for reduction of nitrogen oxides NOₓ in the exhaust stream 203 by utilization of the supplied reductant.

According to an embodiment, the herein described reductant delivery system 400 is utilized in an exhaust treatment system 350 as illustrated in FIG. 3, i.e. in an exhaust treatment system 350 arranged for treatment of an exhaust stream 303 resulting from a combustion in a combustion engine 301. The exhaust treatment system 350 comprises an upstream dosing device 420a arranged to supply a reductant into the exhaust stream 303. The exhaust treatment system 250 further comprises an upstream selective catalytic reduction catalyst 330 arranged downstream of the upstream dosing device 420a for reduction of nitrogen oxides NOₓ in the exhaust stream 303 by utilizing the supplied reductant. The exhaust treatment system 250 further comprises a particulate filter 310 arranged downstream of the upstream selective catalytic reduction catalyst 330 to catch soot and ash created by the combustion. The exhaust treatment system 250 further comprises the herein described reductant delivery system 400, comprising a downstream reductant dosing device 420b and a downstream evaporator 410b, arranged downstream of the particulate filter 310, where the reductant delivery system 400 is configured to mix the reductant with the exhaust stream 303. The exhaust treatment system 250 further comprises a downstream selective catalytic reduction catalyst 320 arranged downstream of the reductant delivery system 400 to reduce nitrogen oxides NOₓ in the exhaust stream 303 by utilizing the supplied reductant.

According to an embodiment, the herein described reductant delivery system 400, comprising an upstream reductant dosing device 420a and an upstream evaporator 410a, is utilized for supplying the reductant into the exhaust stream 303 also upstream of the upstream selective catalytic reduction catalyst 330. Thus, the herein described reductant delivery system 400 then injects reductant both upstream of the upstream selective catalytic reduction catalyst 330 and upstream of the downstream selective catalytic reduction catalyst 320.

The present invention is not limited to the embodiments of the invention described above, but relates to and comprises all embodiments within the scope of the enclosed independent claims.

1. A reductant delivery system configured to supply a reductant into an exhaust stream in an exhaust treatment system, the exhaust stream being a result of a combustion in a combustion engine and the exhaust treatment system being configured for treatment of the exhaust stream by utilization of the reductant, wherein the reductant delivery system comprises:
an evaporator configured to mix the reductant with the exhaust stream flowing through the evaporator;
a reductant doser configured essentially in a center of a cross section of the evaporator to provide the reductant in spray form to a spray transforming device, the cross section being perpendicular to a flow direction of the exhaust stream; and
the spray transforming device configured between the reductant doser and at least one evaporating surface of the evaporator to receive the reductant in spray form from the reductant doser, to transform the reductant from spray form to fluid form, and to deliver the reductant in fluid form at the at least one evaporating surface such that the reductant is distributed as a liquid wall film on the at least one evaporating surface.

2. The reductant delivery system as claimed in claim 1, wherein the spray transforming device is configured as a cone formed wheel comprising:
a hub configured at a top of the cone, wherein the hub comprises at least one spray transforming surface configured to receive the reductant in spray form from the reductant doser and to transform the reductant from spray form to fluid form;
two or more spokes configured from the hub to a rim of the spray transforming device, each spoke comprising a channel configured to provide the reductant in fluid form from the at least one spray transforming surface to the rim; and
the rim configured at a base of the cone, downstream of the hub, to provide the reductant in fluid form at the at least one evaporating surface.

3. The reductant delivery system as claimed in claim 1, wherein
the evaporator comprises two or more concentric evaporation pipes through which the exhaust stream flows, the two or more concentric evaporation pipes forming two or more evaporation surfaces, respectively; and
the spray transforming device is configured as a two or more cone formed wheels having differing base diameters, wherein each cone formed wheel comprises:
a hub configured at a top of the cone, wherein the hub comprises at least one spray transforming surface configured to receive the reductant in spray form from the reductant doser and to transform the reductant from spray form to fluid form;
two or more spokes configured from the hub to a rim of the spray transforming device, each spoke comprising a channel configured to provide the reductant in fluid form from the hub to the rim; and
the rim configured at a base of the cone, downstream of the hub, and being configured to provide the reductant in fluid form at the at least one evaporating surface.

4. The reductant delivery system as claimed in claim 2, wherein the two or more channels of the two or more spokes are arranged on the surfaces of the two or more spokes, respectively.

5. The reductant delivery system as claimed in claim 2, wherein the two or more channels of the two or more spokes are arranged in two or more tunnels under the surfaces of the two or more spokes, respectively.

6. The reductant delivery system as claimed in claim 1, wherein the spray transforming device is arranged separate from the reductant doser at an axial distance downstream of the reductant doser.

7. The reductant delivery system as claimed in clam 1, wherein the spray transforming device is arranged downstream of the reductant doser and attached to the reductant doser.

8. The reductant delivery system as claimed in claim 6, wherein at least one spray transforming surface of the spray transforming device is arranged concealed within a joint between the reductant doser and the spray transforming device.

9. The reductant delivery system as claimed in claim 1, wherein the delivery of the reductant in fluid form at the at least one evaporating surface is configured to avoid transforming the reductant from fluid form into spray form when providing the reductant to the at least one evaporating surface after the reductant has been transformed into fluid form by the spray transforming device.

10. The reductant delivery system as claimed in claim 1, wherein the delivery of the reductant in fluid form at the at least one evaporating surface is configured to prevent individual solid particles having a diameter less than 23 nm from being created by the supply of the reductant into the exhaust stream.

11. The reductant delivery system as claimed in claim 10, wherein the individual solid particles comprise one or more in the group of:
urea; and
by-products based on urea.

12. The reductant delivery system as claimed in claim 1, wherein the reductant comprises one or more in the group of:
ammonia; and
a substance from which ammonia may be extracted and/or released.

13. The reductant delivery system as claimed in claim 1, wherein the spray transforming device is configured to deliver the reductant at a distance in an interval of 0-10 mm from the at least one evaporating surface.

14. An exhaust treatment system arranged for treatment of an exhaust stream resulting from a combustion in a combustion engine the exhaust treatment system comprising:
a particulate filter arranged to catch soot and ash created by the combustion;
a reductant delivery system arranged downstream of the particulate filter, the reductant delivery system configured to supply a reductant into the exhaust stream for treatment of the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in spray form to a spray transforming device, the cross section being perpendicular to a flow direction of the exhaust stream; and
the spray transforming device configured between the reductant doser and at least one evaporating surface of the evaporator to receive the reductant in spray form from the reductant doser, to transform the reductant from spray form to fluid form, and to deliver the reductant in fluid form at the at least one evaporating surface, such that the reductant is distributed as a liquid wall film on the at least one evaporating surface; and
a selective catalytic reduction catalyst arranged downstream of the reductant delivery system for reduction of nitrogen oxides NOₓ in the exhaust stream by utilization of the supplied reductant.

15. An exhaust treatment system arranged for treatment of an exhaust stream resulting from a combustion in a combustion engine, the exhaust treatment system comprising:
an upstream dosing device arranged to supply a reductant into the exhaust stream;
an upstream selective catalytic reduction catalyst arranged downstream of the upstream dosing device for reduction of nitrogen oxides NOₓ in the exhaust stream by utilizing the supplied reductant;
a particulate filter arranged downstream of the upstream selective catalytic reduction catalyst to catch soot and ash created by the combustion;
a reductant delivery system (400) as claimed in any one of claims 1-13 arranged downstream of the particulate filter, the reductant delivery system configured to supply a reductant into the exhaust stream for treatment of the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in spray form to a spray transforming device, the cross section being perpendicular to a flow direction of the exhaust stream; and
the spray transforming device configured between the reductant doser and at least one evaporating surface of the evaporator to receive the reductant in spray form from the reductant doser, to transform the reductant from spray form to fluid form, and to deliver the reductant in fluid form at the at least one evaporating surface, such that the reductant is distributed as a liquid wall film on the at least one evaporating surface; and
a downstream selective catalytic reduction catalyst arranged downstream of the reductant delivery system to reduce nitrogen oxides NOₓ in the exhaust stream by utilizing the supplied reductant.

16. A vehicle comprising an exhaust treatment system arranged for treatment of an exhaust stream resulting from a combustion in a combustion engine of the vehicle, wherein the exhaust treatment system comprises:
a particulate filter arranged to catch soot and ash created by the combustion;
a reductant delivery system arranged downstream of the particulate filter, the reductant delivery system configured to supply a reductant into the exhaust stream for treatment of the exhaust stream, wherein the reductant delivery system comprises:
an evaporator configured to mix the reductant with the exhaust stream flowing through the evaporator;
a reductant doser configured essentially in a center of a cross section of the evaporator to provide the reductant in spray form to a spray transforming device, the cross section being perpendicular to a flow direction of the exhaust stream; and
the spray transforming device configured between the reductant doser and at least one evaporating surface of the evaporator to receive the reductant in spray form from the reductant doser, to transform the reductant from spray form to fluid form, and to deliver the reductant in fluid form at the at least one evaporating surface, such that the reductant is distributed as a liquid wall film on the at least one evaporating surface; and
a selective catalytic reduction catalyst arranged downstream of the reductant delivery system for reduction of nitrogen oxides NOₓ in the exhaust stream by utilization of the supplied reductant.
